(19) United States
(12) Patent Application Publication
(10) Pub. No.: US 2007/0020501 A1
(43) Pub. Date: Jan. 25, 2007

(54) Polyelectrolyte membranes as separator for battery and fuel cell applications

(76) Inventors: Ling-Feng Li, Croton, NY (US); Fuyuan Ma, Yorktown, NY (US); Boris Kukovitskiy, Brooklyn, NY (US); Sadeg M. Faris, Pleasantville, NY (US)

Correspondence Address: REVEO, INC., 3 WESTCHESTER PLAZA, ELMSFORD, NY, 10523, US

(21) Appl. No.: 11/186,937

(22) Filed: Jul. 21, 2005

(51) Int. Cl. H01M 8/10

(52) U.S. Cl. 429/33; 429/309

(57) ABSTRACT

Herein provided are polyelectrolyte membranes that block dendrite growth in rechargeable batteries, possess low inherent electrical resistance to be used as separators, possess high ionic conductivities, and block fuel crossover in direct fuel feeding fuel cells. Further provided are cost-effective processes for forming polyelectrolyte membranes. The herein described polyelectrolyte membranes are useful in electrochemical cells such as primary batteries, secondary batteries such as Ag—Zn, Ni—Zn, Ni-MH, Li polymer, and Li-ion; fuel cells including but not limited to metal air battery or fuel cells, proton exchange membrane hydrogen fuel cells, direct liquid feed fuel cell.

### TECHNICAL FIELD

The present invention is related to separators for batteries and fuel cells, particularly electrically insulating separators with high ionic conductivity.

### BACKGROUND ART

Dendrite growth is a common source of rechargeable battery failure. Dendrite growth is a phenomenon that occurs during battery recharging, whereby active materials, usually metals such as zinc or lithium, are reduced from their oxidized state and deposited onto a substrate (e.g., electrode being charged). Depending on the charging condition, the metal may be deposited a dendritical form, and has potential to penetrate the separator or membrane and short the cell.

Conventional membranes or separators cannot block dendrite growth effectively in rechargeable batteries or fuel cells. For example, zinc dendrite growth is a common problem in Ni—Zn batteries, Ag—Zn batteries, and Zn-Air batteries and fuel cells. Lithium dendrite growth is also common in rechargeable lithium batteries.

Many commercially available separators or membranes depend upon reducing pore size prevent dendrites. However, reduced pore size usually results in increased resistance and decreased ionic conductivity. More importantly, effectively blockage of dendrites is not possible by merely reducing pore size.

In certain commercially available separators or membranes, chemical reactions are used to block dendrites. However, regeneration of the chemical agent is required, or the reactants would be consumed.

It is important for a rechargeable battery to have a high cycle numbers i.e. cycle life. It is also important that components of batteries such as membranes are simple to fabricate and cost effective. The membrane also should have high ionic conductivity and low electrical resistance. A need remains in the art for a membrane having these characteristics.

Furthermore, Nafion® is commonly used in the direct liquid feed (such as methanol, NaBH₄, LiBH₄) fuel cell application. However, fuel crossover is a commonly encountered problem. A membrane that can block the fuel crossover will be highly desirable.

### BRIEF SUMMARY OF THE INVENTION

Herein provided are polyelectrolyte membranes that block dendrite growth in rechargeable batteries, possess low inherent electrical resistance to be used as separators, possess high ionic conductivities, and block fuel crossover in direct fuel feeding fuel cells. Further provided are cost-effective processes for forming polyelectrolyte membranes.

The herein described polyelectrolyte membranes are useful in electrochemical cells such as primary batteries, secondary batteries such as Ag—Zn, Ni—Zn, Ni-MH, Li polymer, and Li-ion; fuel cells including but not limited to metal air battery or fuel cells, proton exchange membrane hydrogen fuel cells, direct liquid feed fuel cell.

### BRIEF DESCRIPTION OF THE FIGURES

The foregoing summary as well as the following detailed description of preferred embodiments of the invention will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings, where:

FIG. 1 is a schematic representation of a membrane formed according to the invention herein; and

FIG. 2 is a schematic representation of the testing apparatus used in certain exampled of the present invention.

### DETAILED DESCRIPTION OF THE FIGURES

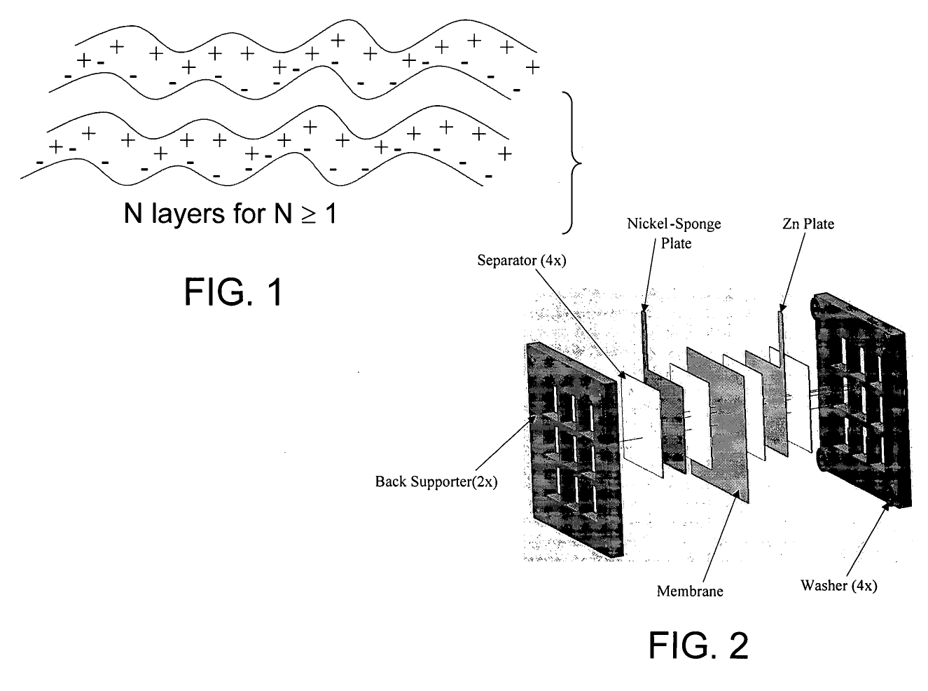

Provided herein are polyelectrolyte membranes including charged polymer chains. In particular, oppositely charged polyelectrolytes are layered and electrical double layers are formed at the interface of the polymer chains (see FIG. 1). Thus, the polymers are held together electrostatically.

In certain embodiments, polyelectrolyte membranes may be prepared layer-by-layer by sequentially immersing a substrate in negatively charged polyelectrolyte (i.e. polyanion) solution, then positively charged polyelectrolyte (i.e. polycation) solution (or vice versa). In further embodiments, this process is repeated in a cyclic procedure to produce polyelectrolyte multilayer membranes.

Novel properties of types including electrical, magnetic, and optical can be derived from simple, low cost, and wet-bench techniques described herein, with oppositely charged polymers.

Examples of positively charged polymers (polycations) include but are not limited to poly(diallyldimethylammonium chloride). Poly(N-methyl-4-vinylpyridinium iodide), poly(allylamine hydrochloride), poly(butyl acrylate-co-N-methyl-4-vinylpyridinium iodide), poly(butadiene-co-N-methyl-4-vinnylpyridinium) iodide, poly(styrene-co-4-vinylpyridine), poly(ethyl acrylate-co-4-vinylpyridine), polyaniline-based polymers, polypyrrole-base polymers, or other suitable polycations.

In one embodiment, a polycation may have the general structure 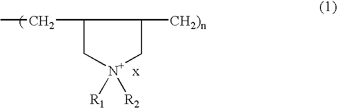
wherein R1 is -Ch3, —CH2CH3, —CH2CH2CH3, —(CH2)ₙCH3, R2 is _—CH3, —CH2CH3, —CH2CH2CH3, —(CH2)ₙCH3; X is Cl⁻, Br⁻, I⁻, F⁻, CO3²⁻, SO4²⁻, PO4³⁻, etc.

Examples of polymers having the above formula 1 include but are not limited to poly(diallyldimethylammonium chloride), poly(allylamine hydrochloride).

In another embodiment, a polycation may have the general structure 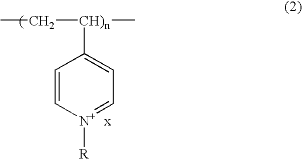
wherein R is —CH3, —CH2CH3, —CH2CH2CH3, —(CH2)ₙCH3, X is Cl⁻, Br⁻, I⁻, F⁻, CO3²⁻, SO4²⁻, PO4³⁻, etc.

Examples of polymers having the above formula 2 include but are not limited to Poly(N-methyl-4-vinylpyridinium iodide).

The negatively charged polyelectrolyte (polyanion) can be any negatively charged polymer. Examples of negatively charged polymers include but are not limited to poly(sodium styrene sulfonate). poly(acrylic acid) sodium salt, poly(acrylic acid)-co-polymers, (poly(styrene-co-sodium styrenesulfonate), poly(sulfone-co-sodium sulfonate), poly(ethy acrylate-co-sodium acrylate), poly(butadiene-co-lithium methacrylate), poly(ethylene-co-sodium methacrylate), poly(ethylene-co-magnesium methacrylate), zinc-sulfonated ethylene-propylen-terpolymer, carboxymethyl cellulose sodium salt, Nafion (Du Pont), PFSI (Dow Chemical).

In one embodiment, a polyanion may have the general structure: 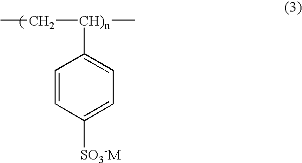
wherein M is Na⁺, Li⁺, K⁺, Zn²⁺, Mg²⁺, Al³⁺, Cu²⁺, Ag⁺, Ni²⁺, etc.

Examples of polymers having the above formula 3 include but are not limited to poly(sodium styrene sulfonate).

In another embodiment, a polyanion may have the general structure: 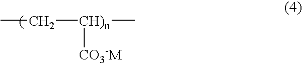
wherein M is Na⁺, Li⁺, K⁺, Zn²⁺, Mg²⁺, Al³⁺, Cu²⁺, Ag⁺, Ni²⁺, etc.

Examples of polymers having the above formula 4 include but are not limited to poly(acrylic acid) sodium salt.

In further embodiments, additives such as neutral polymers may be added to the positively charged, negatively charged or both the positively charged and negatively charged polyelectrolyte solutions. Such additives may include any neutral polymer such as PVA, PEO, PVDF, PPO, PA, PEA, PEEK, PET, PMMA, poly2,6-dimethyl-1,4-phenylene odixe), poly2,6-diphenyl-1,4-phenylene oxide), poly(4-vinylpyridine). Particularly, PVA, PEO, PVDF, and other similar polymers may be used. Such additives may be incorporated into the polyelectrolyte to improve properties including but not limited to the thin-film forming effect of the polyelectrolyte membranes.

In another embodiments, a porous substrate, such as nonwoven nylon, polypropylene (PP) or other suitable substrate may be used. The polyelectrolyte membrane will be coated on top of the substrate.

### EXAMPLE

The following non-limiting example describes an embodiment of the polyelectrolyte membrane.

5% poly(diallyldimethylammonium chloride) plus 3.5% PVA solution was used to coat the nonwoven substrate such as FS2225 from Freudenberg to layer A; and 5% poly(sodium styrene sulfonate) plus 3.5% PVA was used to coate the nonwoven substrate as layer B. Repeat A and B two times, so the result membrane has a general structure of BABABA. Thus, a polyelectrolyte membrane having a thickness of about 0.1 mm to about 0.25 mm was produced. The conductivity is in the order of 10⁻¹ S/cm in 45% KOH.

Using the above described polyelectrolyte membrane, dendrite shorting tests were conducted using the set-up described herein. The herein polyelectrolyte as separator demonstrates longer shorting time as compared to conventional separators (see Table 1).

TABLE 1
Dendrites test with commercial separators
and polyelectrolyte membranes

Separators

| | Celgard | Celgard | Celgard | |
|---|---|---|---|---|
| | 5550 | 5550 | 3407 | Polyelectrolyte |
| | 1 layer | 2 layers | 1 layer | 1 layer |
| Shorting | 1 | 1.3 | 1.6 | 5 |
| Time (hr) | | | | |

The dendrite shorting test is set up as in FIG. 2. In the set-up, Ni-sponge and Zn-plate are used as charging electrodes. The testing membrane is sandwiched between PP separators and the distance is controlled by washers on the back supporters. Rigid back supporters are used to fix the distance of the set-up and screws are used to hold the set-up tightly. During zinc dendrite shorting tests, 45% KOH+6% ZnO electrolyte was used. The Zn-electrode has a size of 3 cm×3 cm and 1A constant current was used for charging. The shorting time was recorded and some typical shorting data is listed in Table 1.

By using the herein polyelectrolyte as separator, the time for dendrite shorting test has been prolonged as shown in Table 1. As the longer time for dendrites shorting is better for a rechargeable battery so as to provide a longer cycle life, higher cycle numbers are expected for rechargeable batteries by using the polyelectrolyte membrane.

While preferred embodiments have been shown and described, various modifications and substitutions may be made thereto without departing from the spirit and scope of the invention. Accordingly, it is to be understood that the present invention has been described by way of illustrations and not limitation.

1. A membrane for an electrochemical cell comprising:
at least one pair of oppositely charged membranes including a polyanion membrane and adjacent a polycation membrane, wherein electrical double layers are formed at the interface of the polyanion and polycation membranes.

2. An electrochemical cell comprising the membrane of claim 1.

3. The membrane as in claim 1, wherein plural, pairs of oppositely charged membranes are provided adjacent one another.

4. The membrane as in claim 1, wherein at least one of the polyanion membrane or the polycation membrane includes a neutral polymer.

5. The membrane as in claim 1, wherein an anionic polymer forming the polyanion membrane is selected from the group consisting of poly(sodium styrene sulfonate). poly(acrylic acid) sodium salt, poly(acrylic acid)-co-polymers, (poly(styrene-co-sodium styrencsulfonate), poly(sulfone-co-sodium sulfonate), poly(ethy acrylate-co-sodium acrylate), poly(butadiene-co-lithium, methacrylate), poly(ethylene-co-sodium methacrylate), poly(ethylene-co-magnesium methacrylate), zinc-sulfonated ethylene-propylen-terpolymer carboxymethyl cellulose sodium salt, Nafion, and other suitable polyanions.

6. The membrane as in claim 1, wherein an anionic polymer forming the polyanion membrane has the structure 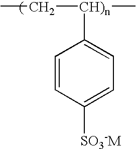
wherein M is selected from the group consisting of Na⁺, Li⁺, K⁺, Zn²⁺, Mg²⁺, Al³⁺, Cu²⁺, Ag⁺, Ni²⁺.

7. The membrane as in claim 1, wherein an anionic polymer forming the polyanion membrane has the structure 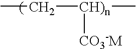
wherein M is selected from the group consisting of Na⁺, Li⁺, K⁺, Zn²⁺, Mg²⁺, Al³⁺, Cu²⁺, Ag⁺, Ni²⁺.

8. The membrane as in claim 1, wherein an cationic polymer forming the polycaiton membrane is selected from the group consisting of poly(diallyldimethylammonium chloride). Poly(N-methyl-4-vinylpyridinium iodide), poly(allylamine hydrochloride), poly(butyl acrylate-co-N-methyl-4-vinylpyridinium iodide), poly(butadiene-co-N-methyl-4-vinnylpyridinium) iodide, poly(styrene-co-4-vinylpyridine), poly(ethyl acrylate-co-4-vinylpyridine), polyaniline-based polymers, polypyrrole-base polymers, and other suitable polycations.

9. The membrane as in claim 1, wherein an cationic polymer forming the polycaiton membrane has the structure 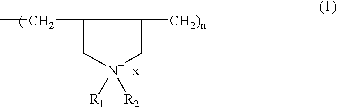
wherein R1 is selected from the group consisting of -Ch3, —CH2CH3, —CH2CH2CH3, —(CH2)ₙCH3, R2 is _—CH3, —CH2CH3, —CH2CH2CH3, —(CH2)ₙCH3; X is Cl⁻, Br⁻, I⁻, F⁻, CO3²⁻, SO4²⁻, PO4³⁻.

10. The membrane as in claim 1, wherein an cationic polymer forming the polycaiton membrane has the structure 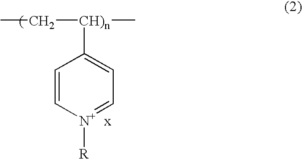
wherein R is selected from the group consisting of —CH3, —CH2CH3, —CH2CH2CH3, —(CH2)ₙCH3, X is Cl⁻, Br⁻, I⁻, F⁻, CO3²⁻, SO4²⁻, PO4³⁻.

11. The membrane as in claim 4, wherein the neutral polymer is selected from the group consisting of PVA, PEO, PVDF, PPO, PA, PEA, PEEK, PET, PMMA, poly2,6-dimethyl-1,4-phenylene odixe), poly2,6-diphenyl-1,4-phenylene oxide), and poly(4-vinylpyridine).

12. The membrane as in claim 1, wherein the polyanion and polycation are formed on a substrate.

13. The membrane as in claim 12, wherein the substrate is a porous substrate.

14. The membrane as in claim 13, wherein the porous substrate comprises nylon or polypropylene.

15. The membrane as in claim 1, wherein the electrochemical cell comprises a secondary battery, and the membrane protects the secondary battery from dendrite related ineffectiveness.

16. The membrane as in claim 1, wherein the electrochemical cell comprises a direct fuel feed fuel cell, and the membrane protects the direct fuel feed fuel cell from fuel crossover.
